(19) United States
(12) Patent Application Publication
(10) Pub. No.: US 2024/0129582 A1
(43) Pub. Date: Apr. 18, 2024

(54) AUTOMATIC CONTENT CLASSIFICATION AND AUDITING

(71) Applicant: International Business Machines Corporation, Armonk, NY (US)

(72) Inventors: Si Tong Zhao, Beijing (CN); Zhong Fang Yuan, Xi'an (CN); Tong Liu, Xi'an (CN); Yi Chen Zhong, shanghai (CN); Yuan Yuan Ding, Shanghai (CN)

(73) Assignee: International Business Machines Corporation, Armonk, NY (US)

(21) Appl. No.: 17/967,165

(22) Filed: Oct. 17, 2022

(51) Int. Cl. H04N 21/454; G06F 16/906; H04N 21/231

(52) U.S. Cl. CPC H04N 21/4542; G06F 16/906; H04N 21/231

(57) ABSTRACT

Using labelled training content, a content classification model is trained. Using the trained content classification model, a label describing a first content is determined. The first content is classified into a category in a set of categories using the label. Responsive to the first content being classified into a category of inappropriate content, the first content is removed from a storage location.

### BACKGROUND

The present invention relates generally to a method, system, and computer program product for content classification. More particularly, the present invention relates to a method, system, and computer program product for improved automatic content classification and auditing.

Content is the information contained with communication media. Content includes one or more of text data (e.g., an email or a novel), audio data (e.g., a voicemail or a recording of a speech), still image or video data (e.g., an image or video clip of a pet cat), or a combination (e.g., a movie with closed captions).

Users often circulate content via communication platforms. For example, a user might upload a video of a pet cat to a social media communications site, or send the video to a friend via email or a messaging application. However, not all content is appropriate for all audiences. Hence, a website operator might want to prevent some types of content from being viewed by some users (e.g., preventing a horror movie from being viewed by children younger than a particular age) or from being viewed by any user (e.g., an unauthorized copy of a move). As well, a website operator might want to prevent content having a particular subject from being distributed in particular countries (e.g., to comply with a local law governing the distribution of such content) or to particular users (e.g., to block threats or other harassing behavior), or to ensure that content has a correct subject label. An operator of an email or a messaging platform might have similar desires. Thus, website operators, operators of email or messaging platforms, and others that host or distribute content typically engage in content auditing. Content auditing is the process of reviewing content to classify the content as to subject, and identify content having an inappropriate subject (i.e., inappropriate content) for additional processing or removal.

The illustrative embodiments recognize that, because there is too much content for humans to review, and humans have a limited tolerance for reviewing inappropriate content, currently available content auditing implementations use a combination of automatic review and human review. Automatic review identifies potentially inappropriate content, and the human review process confirms or reverses the automatic review. Results of the human review process are often used to update model training, refining the automatic review. To automatically review still images and video, currently available content auditing implementations prepare a large amount of labeled data of particular types of inappropriate images for use as negative examples. The labeled image data must be fine-grained—i.e., data of each image in a collection of images or a portion of video must be labelled individually. Unlabeled images are assumed to be appropriate, and are used as positive examples. The negative and positive examples are used to train a machine learning model to identify images of inappropriate content. Similarly, to automatically review audio, currently available content auditing implementations prepare a large amount of labeled data of particular types of audio for use as negative examples, and use unlabeled audio as positive examples. The labeled audio data must be fine-grained—i.e., data of small portions of audio (e.g., fifteen seconds) must be labelled individually. The negative and positive examples are used to train a machine learning model to identify audio including inappropriate content.

Thus, training the required models requires collection of a large number of keywords and their synonyms, or labels for small subsets of an audio or video file, for use in model training. When content includes multiple content modes (e.g., audio plus a text description, or video with audio and text), a multi-modal review model must be trained. In addition, because content that does not fall into an already-labelled category of inappropriate content is considered to be appropriate, when a new category of inappropriate content is added, or users begin using content in new, inappropriate ways, relabeled training data must be developed and the entire model retrained. Thus, currently available content auditing implementations do not scale well with new inappropriate content.

Thus, the illustrative embodiments recognize that there is an unmet need to automatically classify content as inappropriate, using coarse-grained labelling and that scales more easily than currently available implementations to include newly identified inappropriate content. In contrast to fine-grained labelling, which assigns labels on a word, small portion of audio (e.g., fifteen seconds), or still image basis, coarse-grained labelling refers to using one label to describe an entire file or similar unit of content (e.g., one movie, novel, or email).

### SUMMARY

The illustrative embodiments provide a method, system, and computer program product. An embodiment includes a method that trains, using labelled training content, a content classification model. An embodiment determines, using the trained content classification model, a label describing a first content. An embodiment classifies, into a category in a set of categories using the label, the first content. An embodiment removes, from a storage location responsive to the first content being classified into a category of inappropriate content, the first content. Thus, the embodiment provides improved automatic content classification and auditing

In another embodiment, the labelled training content comprises a text label describing the content. Thus, the embodiment provides a particular manner of configuring the labelled training content.

In another embodiment, training, using labelled training content, a content classification model comprises encoding, using a text encoding model, a text label describing the first content, the encoding resulting in a label encoding comprising a multidimensional point in a vector space; encoding, using an image encoding model, a video component of the first content, the encoding resulting in a video encoding comprising a multidimensional point in the vector space; encoding, using an audio encoding model, an audio component of the first content, the encoding resulting in an audio encoding comprising a multidimensional point in the vector space; and adjusting, to minimize a distance between the label encoding, the video encoding, and the audio encoding in the vector space, the text encoding model, the image encoding model, and the audio encoding model. Thus, the embodiment provides a particular manner of training, using labelled training content, a content classification model.

In another embodiment, adjusting the text encoding model, the image encoding model, and the audio encoding model comprises first adjusting, to minimize a first plurality of distances, the text encoding model and the audio encoding model, each distance in the first plurality of distances comprising a distance between a label encoding and a corresponding audio encoding in the vector space; second adjusting, to minimize a second plurality of distances, the text encoding model and the image encoding model, each distance in the second plurality of distances comprising a distance between a label encoding and a corresponding video encoding in the vector space, the second adjusting performed subsequent to the first adjusting; and third adjusting, to minimize a third plurality of distances, the text encoding model and the audio encoding model, each distance in the third plurality of distances comprising a distance between a label encoding and a corresponding audio encoding in the vector space, the third adjusting performed subsequent to the second adjusting. Thus, the embodiment provides a particular manner of adjusting the text encoding model, the image encoding model, and the audio encoding model.

In another embodiment, determining, using the trained content classification model, a label describing the first content comprises encoding, using the image encoding model, a video component of the first content, the encoding resulting in a first video encoding; and determining a label encoding in a set of label encodings that is closest to the first video encoding, the label encoding comprising an encoding of the label describing the first content. Thus, the embodiment provides a particular manner of determining, using the trained content classification model, a label describing the first content.

In another embodiment, determining, using the trained content classification model, a label describing the first content comprises encoding, using the audio encoding model, an audio component of the first content, the encoding resulting in a first audio encoding; and determining a label encoding in a set of label encodings that is closest to the first audio encoding, the label encoding comprising an encoding of the label describing the first content. Thus, the embodiment provides a particular manner of determining, using the trained content classification model, a label describing the first content.

Another embodiment further includes adding, to the set of categories a new content category; generating, for the new content category, a plurality of labels, each label in the plurality of labels comprising a text description of content in the new content category; encoding, using the text encoding model, each of the plurality of labels, the encoding resulting in plurality of label encodings, each label encoding in the plurality of label encodings comprising a multidimensional point in a vector space; determining, using the trained content classification model, a label describing a first content; determining, using the trained content classification model, a second label describing a second content; and classifying, into the new content category using the second label, the second content. Thus, the embodiment provides additional steps in improved automatic content classification and auditing.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts an example diagram of a data processing environments in which illustrative embodiments may be implemented;

FIG. 2 depicts a block diagram of an example configuration for improved automatic content classification and auditing in accordance with an illustrative embodiment;

FIG. 3 depicts an example of improved automatic content classification and auditing in accordance with an illustrative embodiment;

FIG. 4 depicts an example of improved automatic content classification and auditing in accordance with an illustrative embodiment;

FIG. 5 depicts an example of improved automatic content classification and auditing in accordance with an illustrative embodiment;

FIG. 6 depicts an example of improved automatic content classification and auditing in accordance with an illustrative embodiment;

FIG. 7 depicts a flowchart of an example process for improved automatic content classification and auditing in accordance with an illustrative embodiment.

### DETAILED DESCRIPTION

The illustrative embodiments recognize that there is an unmet need to automatically classify content as inappropriate, using coarse-grained labelling and that scales more easily than currently available implementations to include newly identified inappropriate content, for use in content auditing and for other uses.

The illustrative embodiments recognize that the presently available tools or solutions do not address these needs or provide adequate solutions for these needs. The illustrative embodiments used to describe the invention generally address and solve the above-described problems and other problems related to improved automatic content classification and auditing.

An embodiment can be implemented as a software application. The application implementing an embodiment can be configured as a modification of an existing content classification or auditing system, as a separate application that operates in conjunction with an existing content classification or auditing system, a standalone application, or some combination thereof.

Particularly, some illustrative embodiments provide a method that trains, using labelled training content, a content classification model, determines, using the trained content classification model, a label describing a first content, classifies, into a category in a set of categories using the label, the first content, and removes, from a storage location responsive to the first content being classified into a category of inappropriate content, the first content.

An embodiment receives training contents with coarse-grained labels. In particular, each training content includes an audio component and a video component, as well as a label in text form describing the entire training content. For example, one training content might include several minutes of video depicting an orange cat, audio including sounds made by the cat, and a text label: “This video shows an orange cat with green eyes lying on a brown sofa.”

An embodiment preprocesses the text of a training content's label, including using presently available techniques to segment the text into words or other word-like subsets, remove extraneous words and punctuation, and the like. After preprocessing, an embodiment converts each word or other word-like subset remaining in the label text into a corresponding word encoding. A word encoding, also called a word embedding, is a multidimensional representation of a word in a vector space. Word encodings are selected by a trained model so that similar words have correspondingly similar word encodings, thus allowing similarity measurement between words to be performed by measuring similarity between the words' encodings. Techniques for training a word encoding model, using the model to convert words to word encodings (e.g., using the word2vec technique), and computing similarity between encodings (e.g., cosine similarity) are presently available. An embodiment uses a text encoding model to convert the word encodings of one text label into a label encoding, a multidimensional representation of an entire label in a vector space. A text encoding represents one or more features of the encoded text in numerical form. Techniques for performing text encoding (e.g., Bidirectional Encoder Representations from Transformers (BERT) and the Generative Pre-trained Transformer (GPT) family (GPT-2 and GPT-3)) are also presently available.

An embodiment preprocesses the audio component of a training content, including using presently available techniques to preprocess the audio component (e.g., using low-frequency filtering, noise removal, amplitude normalization, and other presently available audio processing techniques), dividing the preprocessed audio component into segments, and converting each segment into a corresponding audio segment encoding. An audio encoding is a multidimensional representation of an audio segment in a vector space. Audio encodings are selected by a trained model so that similar audio segments have correspondingly similar encodings, thus allowing similarity measurement between audio segments to be performed by measuring similarity between the segments' encodings. Techniques for training the audio segment encoding model and using the model to convert audio segments to corresponding encodings (e.g., making use of Mel-frequency cepstral coefficients (MFCCs) or the log mel-spectrogram separation technique) are presently available. An embodiment uses an audio encoding model to convert the audio segment encodings of training content audio component into an audio encoding, a multidimensional representation of an entire audio component in a vector space. An audio encoding represents one or more features of the encoded audio in numerical form. Techniques for performing audio encoding (e.g., using the wav2vec technique, using a convolutional neural network (CNN), or using an autoencoder neural network) are also presently available.

An embodiment extracts features from frames within the video component of a training content, using a presently available technique such as a trained convolutional neural network. An embodiment uses a video encoding model to convert the extracted features into a video encoding, a multidimensional representation of an entire video component in a vector space. A video encoding represents one or more features of the video component in numerical form. Techniques for performing video encoding are also presently available.

Because a text encoding, audio encoding, and video encoding all represent different features of the same content, an embodiment uses a contrastive learning technique to train the text, audio, and video encoding models together. Contrastive learning is a presently available machine learning technique used to learn the general features of a dataset without labels by teaching a model which data points are similar or different. However, an embodiment uses three different training epochs, while the traditional contrastive learning technique uses one epoch. In particular, if there are n training contents in a training set, the set of text encodings is represented by T₁, T₂, . . . , Tₙ, the set of audio encodings is represented by A₁, A₂, . . . , Aₙ, and the set of image or video encodings is represented by I₁, I₂, . . . , Iₙ. IᵢAⱼTₖ represents the vector distance between Iᵢ, Aⱼ, and Tₖ, where i, j, and k are index variables. The encoding models are to be trained so that IᵢAᵢTᵢ, the vector distance between encodings corresponding to the same content, is minimized. Thus, in a first training epoch an embodiment trains the audio encoder and text encoder by setting IᵢAⱼTₖ=AⱼTₖ and uses a contrastive learning technique to train all of the IᵢAⱼTₖ according to the target function min (I₁A₁T₁, I₂A₂T₂, . . . , IₙAₙTₙ). In a second training epoch an embodiment trains the video encoder and text encoder by setting IᵢAⱼTₖ=IᵢTₖ, and uses a contrastive learning technique to train all of the IᵢAⱼTₖ according to the target function min (I₁A₁T₁, I₂A₂T₂, IₙAₙTₙ). In a third training epoch an embodiment trains the audio encoder and text encoder by setting IᵢAⱼTₖ=AⱼTₖ, and uses a contrastive learning technique to train all of the IᵢAⱼTₖ according to the target function min (I₁A₁T₁, I₂A₂T₂, . . . IₙAₙTₙ).

An embodiment receives content category data. Content category data is data an embodiment uses to generate a label to be applied to received content being classified. In one embodiment, content category data includes data with which to fill in one or more label templates. Some non-limiting examples of label templates are a default template, a shape feature description, a color feature description, a sound feature description, and the like. An example default template might be “there is [object] in the picture”, where “[object]” is a placeholder for a particular object, such as a cat or a table. One embodiment prompts a user to enter as much descriptive data as possible into label templates, as additional descriptive data helps an embodiment classify content. For example, the embodiment might prompt a user to include not just a bird, but particular colors of birds. The implementation uses the filled-in label templates as labels and generates corresponding label encodings in a manner described herein. In another embodiment, content category data includes fine-grained label data of portions of a content, and the embodiment converts the fine-grained label data to a label describing an entire content, and generates a corresponding label encoding in a manner described herein. To convert fine-grained label data to a label describing an entire content, an embodiment identifies entities within the label data using presently available entity recognition and entity category classification techniques, and fills in a label template with the identified entities and descriptive data extracted from the fine-grained label data.

An embodiment uses the trained text, audio, and video encoding models (collectively referred to as a trained content classification model) to determine a label describing a non-training content. In particular, an embodiment determines a label encoding for a generated or received label by preprocessing the label text and converting each word or other word-like subset remaining in the label text into a corresponding word encoding in a manner described herein, then using the trained text encoding model to generate a label encoding corresponding to the label. One embodiment generates and stores a plurality of label encodings for later application to incoming content.

To classify audio content, an embodiment preprocesses audio of the content, divides the preprocessed audio into segments, and converts each segment into a corresponding audio segment encoding in a manner described herein. An embodiment uses the trained audio encoding model to convert the audio segment encodings into an audio encoding, a multidimensional representation of the audio content in a vector space. An embodiment labels the audio encoding with the label encoding that is most similar to the audio encoding. In other words, the label corresponding to the most similar label encoding is the best description of the audio content. To compute similarity between encodings, an embodiment uses a presently available technique such as cosine similarity.

To classify video content, an embodiment extracts features from frames within video of the content in a manner described herein, and uses the trained video encoding model to convert the extracted features into a video encoding. The video encoding is a multidimensional representation of the video content in a vector space. An embodiment labels the video encoding with the label encoding that is most similar to the video encoding. In other words, the label corresponding to the most similar label encoding is the best description of the video content.

An embodiment uses the label corresponding to the most similar label encoding to classify the labelled content into a category in a set of categories. In one embodiment, there are two categories: appropriate content and inappropriate content. In another embodiment, there are multiple categories, some of which are further identified as appropriate content or inappropriate content. For example, there might be a “cat pictures” category, which could be further identified as appropriate or inappropriate depending on a particular communications platform's needs. If the content is classified into an inappropriate content category, one embodiment removes the content from a storage location, or prevents the content from being stored in the storage location. If the content is classified into an inappropriate content category, another embodiment flags the content for review by a human expert for possible removal.

To add a new content category for classification as inappropriate content, an embodiment generates one or more content labels for content in the new category in a manner described herein, and classifies new content into the new category (as well as other categories) in a manner described herein.

The manner of improved automatic content classification and auditing described herein is unavailable in the presently available methods in the technological field of endeavor pertaining to automatic content classification. A method of an embodiment described herein, when implemented to execute on a device or data processing system, comprises substantial advancement of the functionality of that device or data processing system in training, using labelled training content, a content classification model, determining, using the trained content classification model, a label describing a first content, classifying, into a category in a set of categories using the label, the first content, and removing, from a storage location responsive to the first content being classified into a category of inappropriate content, the first content.

The illustrative embodiments are described with respect to certain types of labels, images, audio components, video components, encodings, distances, preprocessings, segmentations, adjustments, sensors, measurements, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

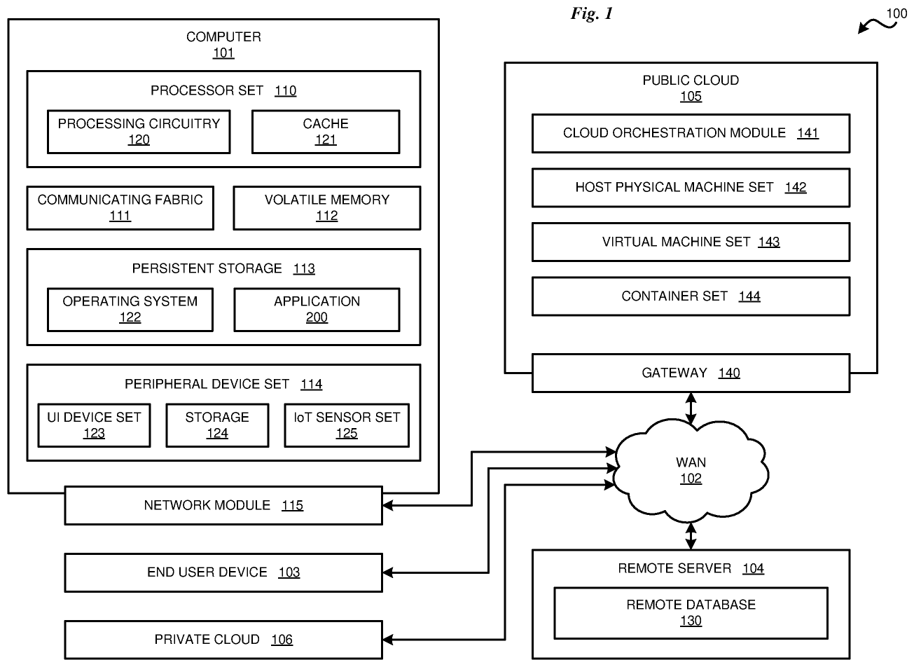

With reference to the figures and in particular with reference to FIG. 1, this figure is an example diagram of a data processing environments in which illustrative embodiments may be implemented. FIG. 1 is only an example and are not intended to assert or imply any limitation with regard to the environments in which different embodiments may be implemented. A particular implementation may make many modifications to the depicted environments based on the following description. FIG. 1 depicts a block diagram of a network of data processing systems in which illustrative embodiments may be implemented. Computing environment 100 contains an example of an environment for the execution of at least some of the computer code involved in performing the inventive methods, such as application 200. Application 200 implements an automatic content classification and auditing embodiment described herein. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144. Application 200 executes in any of computer 101, end user device 103, remote server 104, or a computer in public cloud 105 or private cloud 106 unless expressly disambiguated.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processor set 110 may contain one or more processors and may be implemented using one or more heterogeneous processor systems. A processor in processor set 110 may be a single- or multi-core processor or a graphics processor. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Operating system 122 runs on computer 101. Operating system 122 coordinates and provides control of various components within computer 101. Instructions for operating system 122 are located on storage devices, such as persistent storage 113, and may be loaded into at least one of one or more memories, such as volatile memory 112, for execution by processor set 110.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods of application 200 may be stored in persistent storage 113 and may be loaded into at least one of one or more memories, such as volatile memory 112, for execution by processor set 110. The processes of the illustrative embodiments may be performed by processor set 110 using computer implemented instructions, which may be located in a memory, such as, for example, volatile memory 112, persistent storage 113, or in one or more peripheral devices in peripheral device set 114. Furthermore, in one case, application 200 may be downloaded over WAN 102 from remote server 104, where similar code is stored on a storage device. In another case, application 200 may be downloaded over WAN 102 to remote server 104, where downloaded code is stored on a storage device.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in application 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, user interface (UI) device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. Internet of Things (IoT) sensor set 125 is made up of sensors that can be used in IoT applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

Wide area network (WAN) 102 is any WAN (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

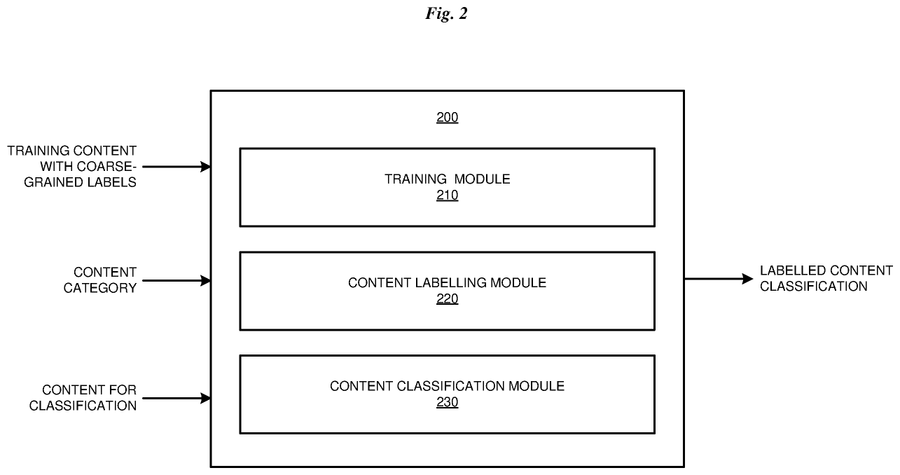

With reference to FIG. 2, this figure depicts a block diagram of an example configuration for improved automatic content classification and auditing in accordance with an illustrative embodiment. Application 200 is the same as application 200 in FIG. 1.

Application 200 receives training contents with coarse-grained labels. In particular, each training content includes an audio component and a video component, as well as a label in text form describing the entire training content.

Training module 210 preprocesses the text of a training content's label, including using presently available techniques to segment the text into words or other word-like subsets, remove extraneous words and punctuation, and the like. After preprocessing, module 210 converts each word or other word-like subset remaining in the label text into a corresponding word encoding. Module 210 uses a text encoding model to convert the word encodings of one text label into a label encoding, a multidimensional representation of an entire label in a vector space.

Module 210 preprocesses the audio component of a training content, including using presently available techniques to preprocess the audio component (e.g., using low-frequency filtering, noise removal, amplitude normalization, and other presently available audio processing techniques), dividing the preprocessed audio component into segments, and converting each segment into a corresponding audio segment encoding. Module 210 uses an audio encoding model to convert the audio segment encodings of training content audio component into an audio encoding, a multidimensional representation of an entire audio component in a vector space.

Module 210 extracts features from frames within the video component of a training content. Module 210 uses a video encoding model to convert the extracted features into a video encoding, a multidimensional representation of an entire video component in a vector space.

Because a text encoding, audio encoding, and video encoding all represent different features of the same content, module 210 uses a contrastive learning technique to train the text, audio, and video encoding models together. Module 210 uses three different training epochs, while the traditional contrastive learning technique uses one epoch. In particular, if there are n training contents in a training set, the set of text encodings is represented by T₁, T₂, . . . , Tₙ, the set of audio encodings is represented by A₁, A₂, . . . , Aₙ, and the set of image or video encodings is represented by I₁, I₂, . . . , Iₙ. IᵢAⱼTₖ represents the vector distance between Iᵢ, Aⱼ, and Tₖ, where i, j, and k are index variables. The encoding models are to be trained so that IᵢAᵢTᵢ, the vector distance between encodings corresponding to the same content, is minimized. Thus, in a first training epoch module 210 trains the audio encoder and text encoder by setting IᵢAⱼTₖ=AⱼTₖ and uses a contrastive learning technique to train all of the IᵢAⱼTₖ according to the target function min (I₁A₁T₁, I₂A₂T₂, . . . IₙAₙTₙ). In a second training epoch module 210 trains the video encoder and text encoder by setting IᵢAⱼTₖ=IᵢTₖ, and uses a contrastive learning technique to train all of the IᵢAⱼTₖ according to the target function min (I₁A₁T₁, I₂A₂T₂, . . . IₙAₙTₙ). In a third training epoch module 210 trains the audio encoder and text encoder by setting IᵢAⱼTₖ=AⱼTₖ, and uses a contrastive learning technique to train all of the IᵢAⱼTₖ according to the target function min (I₁A₁T₁, I₂A₂T₂, . . . IₙAₙTₙ).

Application 200 receives content category data. Content category data is data used to generate a label to be applied to received content being classified. In one implementation of application 200, content category data includes data with which to fill in one or more label templates. One implementation of labelling module 220 prompts a user to enter as much descriptive data as possible into label templates, as additional descriptive data helps classify content. The implementation uses the filled-in label templates as labels and generates corresponding label encodings in a manner described herein. In another implementation of application 200, content category data includes fine-grained label data of portions of a content, and module 220 converts the fine-grained label data to a label describing an entire content, and generates a corresponding label encoding in a manner described herein. To convert fine-grained label data to a label describing an entire content, module 220 identifies entities within the label data using presently available entity recognition and entity category classification techniques, and fills in a label template with the identified entities and descriptive data extracted from the fine-grained label data.

Application 200 uses the trained text, audio, and video encoding models (collectively referred to as a trained content classification model) to determine a label describing a non-training content. In particular, labelling module 220 determines a label encoding for a generated or received label by preprocessing the label text and converting each word or other word-like subset remaining in the label text into a corresponding word encoding in a manner described herein, then using the trained text encoding model to generate a label encoding corresponding to the label. One implementation of module 220 generates and stores a plurality of label encodings for later application to incoming content.

To classify audio content, content classification module 230 preprocesses audio of the content, divides the preprocessed audio into segments, and converts each segment into a corresponding audio segment encoding in a manner described herein. Module 230 uses the trained audio encoding model to convert the audio segment encodings into an audio encoding, a multidimensional representation of the audio content in a vector space. Module 230 labels the audio encoding with the label encoding that is most similar to the audio encoding. In other words the label corresponding to the most similar label encoding is the best description of the audio content. To compute similarity between encodings, module 230 uses a presently available technique such as cosine similarity.

To classify video content, module 230 extracts features from frames within video of the content in a manner described herein, and uses the trained video encoding model to convert the extracted features into a video encoding. The video encoding is a multidimensional representation of the video content in a vector space. Module 230 labels the video encoding with the label encoding that is most similar to the video encoding. In other words, the label corresponding to the most similar label encoding is the best description of the video content.

Module 230 uses the label corresponding to the most similar label encoding to classify the labelled content into a category in a set of categories. In one implementation of module 230, there are two categories: appropriate content and inappropriate content. In another implementation of module 230, there are multiple categories, some of which are further identified as appropriate content or inappropriate content. If the content is classified into an inappropriate content category, one implementation of module 230 removes the content from a storage location, or prevents the content from being stored in the storage location. If the content is classified into an inappropriate content category, another implementation of module 230 flags the content for review by a human expert for possible removal.

To add a new content category for classification as inappropriate content, application 200 generates one or more content labels for content in the new category in a manner described herein, and classifies new content into the new category (as well as other categories) in a manner described herein.

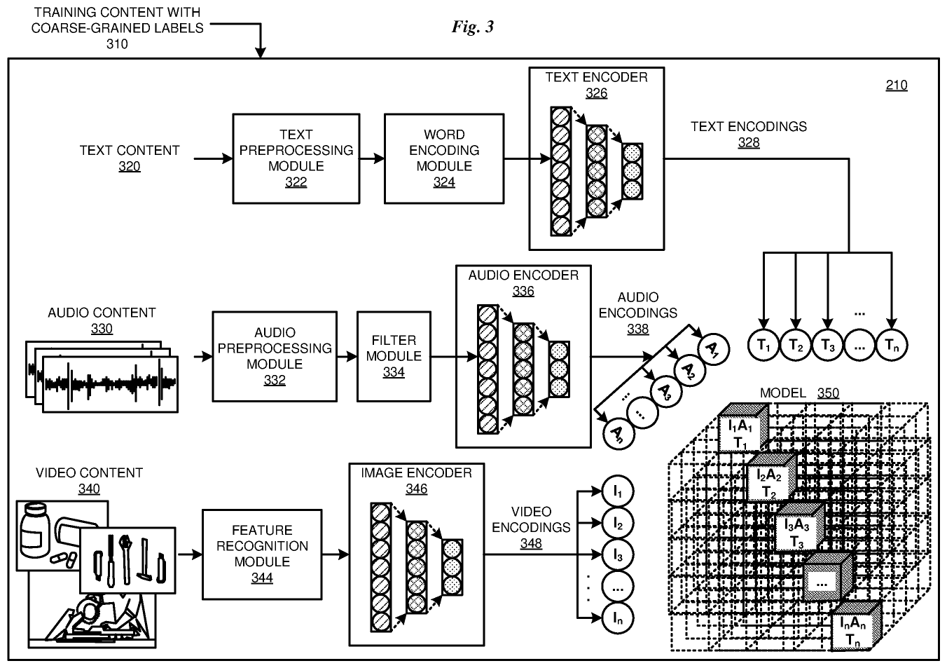

With reference to FIG. 3, this figure depicts an example of improved automatic content classification and auditing in accordance with an illustrative embodiment. Training module 210 is the same as training module 210 in FIG. 2.

Module 210 receives training contents with coarse-grained labels 310. In particular, each training content includes an audio component 330, video component 340, and text content 320—a label in text form describing the entire training content.

Text preprocessing module 322 preprocesses text content 320, including using presently available techniques to segment the text into words or other word-like subsets, remove extraneous words and punctuation, and the like. After preprocessing, word encoding module 324 converts each word or other word-like subset remaining in the label text into a corresponding word encoding. Text encoder 326 converts the word encodings of each text label into label encodings 328.

Audio preprocessing module 332 preprocesses audio content 330. Filter module 334 filters the preprocessed audio content. Audio encoder 336 generates audio encodings 338.

Feature recognition module 344 extracts features from frames within video content 340. Image encoder 346 converts the extracted features into video encodings 348.

Model 350 depicts training of text encoder 326, audio encoder 336, and image encoder 346 by setting IᵢAⱼTₖ=AⱼTₖ and training all of the IᵢAⱼTₖ according to the target function min(I₁A₁T₁, I₂A₂T₂, . . . IₙAₙTₙ), then setting IᵢAⱼTₖ=IᵢTₖ and training all of the IᵢAⱼTₖ according to the target function min(I₁A₁T₁, I₂A₂T₂, . . . IₙAₙTₙ), and setting IᵢAⱼTₖ=AⱼTₖ, and training all of the IᵢAⱼTₖ according to the target function min(I₁A₁T₁, I₂A₂T₂, . . . IₙAₙTₙ).

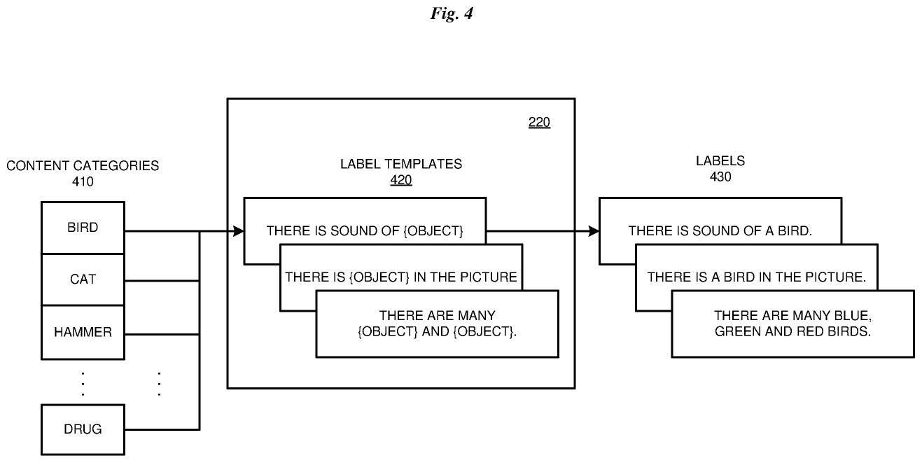

With reference to FIG. 4, this figure depicts an example of improved automatic content classification and auditing in accordance with an illustrative embodiment. Labelling module 220 is the same as labelling module 220 in FIG. 2.

In particular, labelling module 220 uses data from content categories 410 to fill in label templates 420, generating labels 430. Module 220 generates corresponding label encodings from labels 430 in a manner described herein.

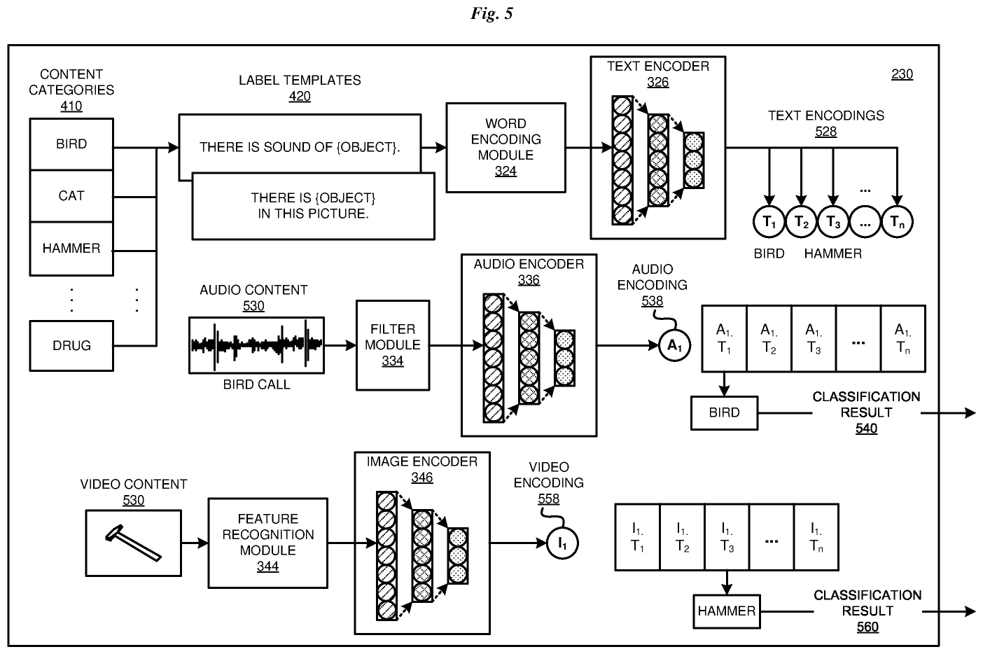

With reference to FIG. 5, this figure depicts an example of improved automatic content classification and auditing in accordance with an illustrative embodiment. Content classification module 230 is the same as content classification module 230 in FIG. 2. Word encoding module 324, text encoder 326, filter module 334, audio encoder 336, feature recognition module 344, and image encoder 346 are the same as word encoding module 324, text encoder 326, filter module 334, audio encoder 336, feature recognition module 344, and image encoder 346. Content categories 410 and label templates 420 are the same as content categories 410 and label templates 420 in FIG. 4.

Data from content categories 410 is used to fill in label templates 420, generating labels, which are processed by word encoding module 324 and text encoder 326, generating text encodings 528. In text encodings 528, T₁ is an encoding corresponding to a description of a bird and T₃ is an encoding corresponding to a hammer.

Filter module 334 filters (optionally preprocessed) audio content 530, audio of a bird call. Audio encoder 336 generates audio encoding 538. Content classification module 230 labels audio encoding 538 with the label encoding within text encodings 528 that is most similar to audio encoding 538. In other words, the label corresponding to the most similar label encoding (T₁ describing a bird) is the best description of the audio content (A₁ encoding a bird call)—classification result 540.

Feature recognition module 344 extracts features from frames within video content 530. Image encoder 346 converts the extracted features into video encoding 558. Content classification module 230 labels video encoding 558 with the label encoding within text encodings 528 that is most similar to video encoding 558. In other words, the label corresponding to the most similar label encoding (T₃ describing a hammer) is the best description of the video content (I₁ encoding a hammer)—classification result 560.

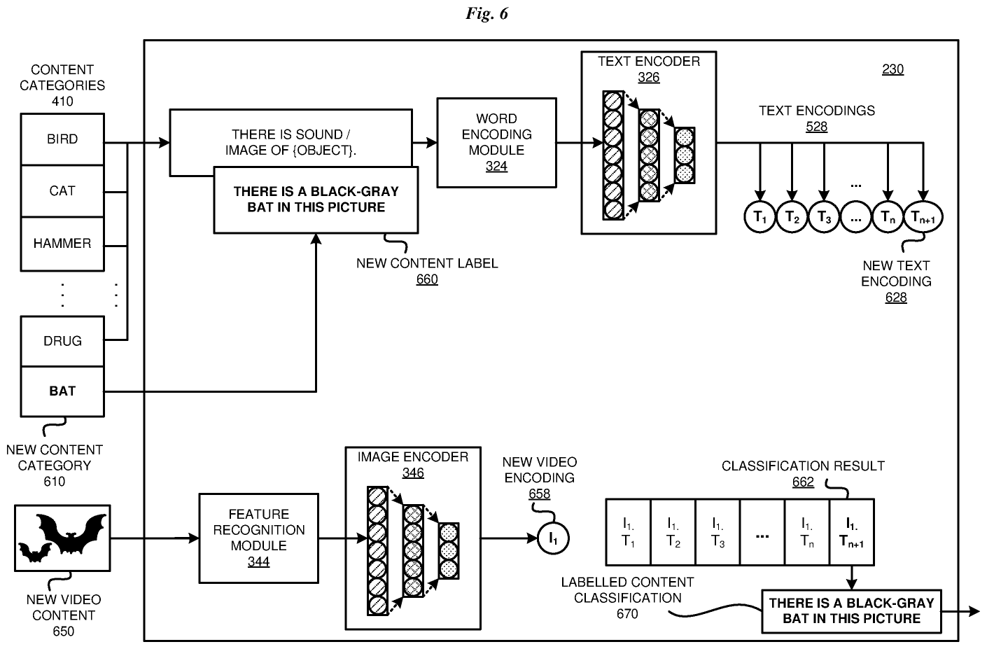

With reference to FIG. 6, this figure depicts an example of improved automatic content classification and auditing in accordance with an illustrative embodiment. Content classification module 230 is the same as content classification module 230 in FIG. 2. Word encoding module 324, text encoder 326, feature recognition module 344, and image encoder 346 are the same as word encoding module 324, text encoder 326, recognition module 334, and image encoder 346. Content categories 410 is the same as content categories 410 in FIG. 4. Text encodings 528 is the same as text encodings 528 in FIG. 5.

As depicted, new content category 610 (bat) has been added to content categories 410, to facilitate recognition of bats as inappropriate content. New content label 660 is generated, and text encoder 326 generates new text encoding 628 (added to text encodings 528).

Feature recognition module 344 extracts features from frames within new video content 650. Image encoder 346 converts the extracted features into new video encoding 658. Content classification module 230 labels video encoding 658 with the label encoding within text encodings 528 that is most similar to video encoding 658. In other words, the label corresponding to the most similar label encoding (Tₙ₊₁ describing a bat) is the best description of the video content (I₁ encoding a bat)—classification result 662 described by labelled classification result 670.

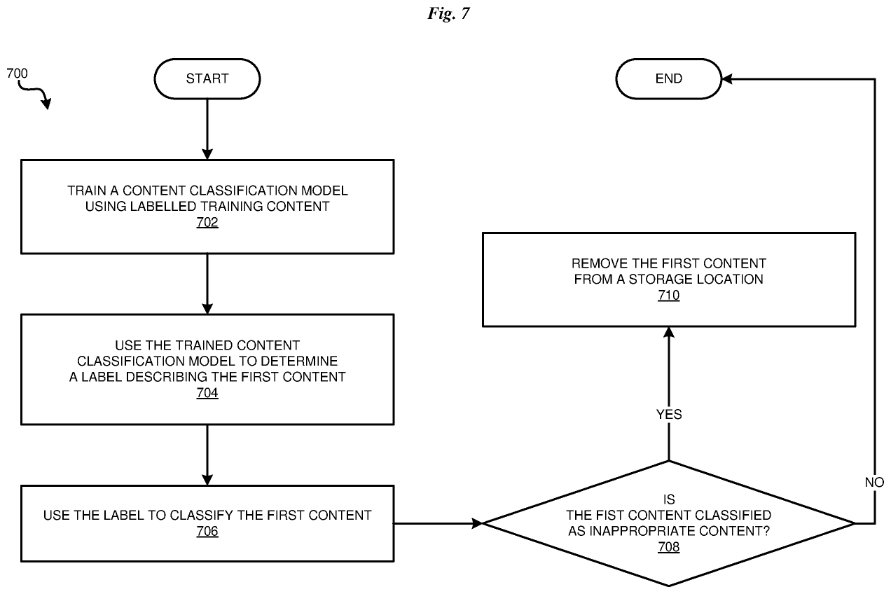

With reference to FIG. 7, this figure depicts a flowchart of an example process for improved automatic content classification and auditing in accordance with an illustrative embodiment. Process 700 can be implemented in application 200 in FIG. 2.

In block 702, the application trains a content classification model using labelled training content. In block 704, the application uses the trained content classification model to determine a label describing the first content. In block 706, the application uses the label to classify the first content. In block 708, the application determines whether the first content was classified as inappropriate content. If yes (“YES” path of block 708, in block 710, the application removes the first content from a storage location. Then (also “NO” path of block 708), the application ends.

Thus, a computer implemented method, system or apparatus, and computer program product are provided in the illustrative embodiments for improved automatic content classification and auditing and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method comprising:
training, using labelled training content, a content classification model;
determining, using the trained content classification model, a label describing a first content;
classifying, into a category in a set of categories using the label, the first content; and
removing, from a storage location responsive to the first content being classified into a category of inappropriate content, the first content.

2. The computer-implemented method of claim 1, wherein the labelled training content comprises a text label describing the content.

3. The computer-implemented method of claim 1, wherein training, using the labelled training content, the content classification model comprises:
encoding, using a text encoding model, a text label describing the first content, the encoding resulting in a label encoding comprising a multidimensional point in a vector space;
encoding, using an image encoding model, a video component of the first content, the encoding resulting in a video encoding comprising a multidimensional point in the vector space;
encoding, using an audio encoding model, an audio component of the first content, the encoding resulting in an audio encoding comprising a multidimensional point in the vector space; and
adjusting, to minimize a distance between the label encoding, the video encoding, and the audio encoding in the vector space, the text encoding model, the image encoding model, and the audio encoding model.

4. The computer-implemented method of claim 3, wherein adjusting the text encoding model, the image encoding model, and the audio encoding model comprises:
first adjusting, to minimize a first plurality of distances, the text encoding model and the audio encoding model, each distance in the first plurality of distances comprising a distance between a label encoding and a corresponding audio encoding in the vector space;
second adjusting, to minimize a second plurality of distances, the text encoding model and the image encoding model, each distance in the second plurality of distances comprising a distance between a label encoding and a corresponding video encoding in the vector space, the second adjusting performed subsequent to the first adjusting; and
third adjusting, to minimize a third plurality of distances, the text encoding model and the audio encoding model, each distance in the third plurality of distances comprising a distance between a label encoding and a corresponding audio encoding in the vector space, the third adjusting performed subsequent to the second adjusting.

5. The computer-implemented method of claim 3, wherein determining, using the trained content classification model, the label describing the first content comprises:
encoding, using the image encoding model, a video component of the first content, the encoding resulting in a first video encoding; and
determining a label encoding in a set of label encodings that is closest to the first video encoding, the label encoding comprising an encoding of the label describing the first content.

6. The computer-implemented method of claim 3, wherein determining, using the trained content classification model, the label describing the first content comprises:
encoding, using the audio encoding model, an audio component of the first content, the encoding resulting in a first audio encoding; and
determining a label encoding in a set of label encodings that is closest to the first audio encoding, the label encoding comprising an encoding of the label describing the first content.

7. The computer-implemented method of claim 3, further comprising:
adding, to the set of categories a new content category;
generating, for the new content category, a plurality of labels, each label in the plurality of labels comprising a text description of content in the new content category;
encoding, using the text encoding model, each of the plurality of labels, the encoding resulting in plurality of label encodings, each label encoding in the plurality of label encodings comprising a multidimensional point in a vector space;
determining, using the trained content classification model, a label describing a first content;
determining, using the trained content classification model, a second label describing a second content; and
classifying, into the new content category using the second label, the second content.

8. A computer program product comprising one or more computer readable storage medium, and program instructions collectively stored on the one or more computer readable storage medium, the program instructions executable by a processor to cause the processor to perform operations comprising:
training, using labelled training content, a content classification model;
determining, using the trained content classification model, a label describing a first content;
classifying, into a category in a set of categories using the label, the first content; and
removing, from a storage location responsive to the first content being classified into a category of inappropriate content, the first content.

9. The computer program product of claim 8, wherein the stored program instructions are stored in a computer readable storage device in a data processing system, and wherein the stored program instructions are transferred over a network from a remote data processing system.

10. The computer program product of claim 8, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

11. The computer program product of claim 8, wherein the labelled training content comprises a text label describing the content.

12. The computer program product of claim 8, wherein training, using labelled training content, the content classification model comprises:
encoding, using a text encoding model, a text label describing the first content, the encoding resulting in a label encoding comprising a multidimensional point in a vector space;
encoding, using an image encoding model, a video component of the first content, the encoding resulting in a video encoding comprising a multidimensional point in the vector space;
encoding, using an audio encoding model, an audio component of the first content, the encoding resulting in an audio encoding comprising a multidimensional point in the vector space; and
adjusting, to minimize a distance between the label encoding, the video encoding, and the audio encoding in the vector space, the text encoding model, the image encoding model, and the audio encoding model.

13. The computer program product of claim 12, wherein adjusting the text encoding model, the image encoding model, and the audio encoding model comprises:
first adjusting, to minimize a first plurality of distances, the text encoding model and the audio encoding model, each distance in the first plurality of distances comprising a distance between a label encoding and a corresponding audio encoding in the vector space;
second adjusting, to minimize a second plurality of distances, the text encoding model and the image encoding model, each distance in the second plurality of distances comprising a distance between a label encoding and a corresponding video encoding in the vector space, the second adjusting performed subsequent to the first adjusting; and
third adjusting, to minimize a third plurality of distances, the text encoding model and the audio encoding model, each distance in the third plurality of distances comprising a distance between a label encoding and a corresponding audio encoding in the vector space, the third adjusting performed subsequent to the second adjusting.

14. The computer program product of claim 12, wherein determining, using the trained content classification model, the label describing the first content comprises:
encoding, using the image encoding model, a video component of the first content, the encoding resulting in a first video encoding; and
determining a label encoding in a set of label encodings that is closest to the first video encoding, the label encoding comprising an encoding of the label describing the first content.

15. The computer program product of claim 12, wherein determining, using the trained content classification model, the label describing the first content comprises:
encoding, using the audio encoding model, an audio component of the first content, the encoding resulting in a first audio encoding; and
determining a label encoding in a set of label encodings that is closest to the first audio encoding, the label encoding comprising an encoding of the label describing the first content.

16. The computer program product of claim 12, further comprising:
adding, to the set of categories a new content category;
generating, for the new content category, a plurality of labels, each label in the plurality of labels comprising a text description of content in the new content category;
encoding, using the text encoding model, each of the plurality of labels, the encoding resulting in plurality of label encodings, each label encoding in the plurality of label encodings comprising a multidimensional point in a vector space;
determining, using the trained content classification model, a label describing a first content;
determining, using the trained content classification model, a second label describing a second content; and
classifying, into the new content category using the second label, the second content.

17. A computer system comprising a processor and one or more computer readable storage media, and program instructions collectively stored on the one or more computer readable storage media, the program instructions executable by the processor to cause the processor to perform operations comprising:
training, using labelled training content, a content classification model;
determining, using the trained content classification model, a label describing a first content;
classifying, into a category in a set of categories using the label, the first content; and
removing, from a storage location responsive to the first content being classified into a category of inappropriate content, the first content.

18. The computer system of claim 17, wherein the labelled training content comprises a text label describing the content.

19. The computer system of claim 17, wherein training, using labelled training content, the content classification model comprises:
encoding, using a text encoding model, a text label describing the first content, the encoding resulting in a label encoding comprising a multidimensional point in a vector space;
encoding, using an image encoding model, a video component of the first content, the encoding resulting in a video encoding comprising a multidimensional point in the vector space;
encoding, using an audio encoding model, an audio component of the first content, the encoding resulting in an audio encoding comprising a multidimensional point in the vector space; and
adjusting, to minimize a distance between the label encoding, the video encoding, and the audio encoding in the vector space, the text encoding model, the image encoding model, and the audio encoding model.

20. The computer system of claim 19, wherein adjusting the text encoding model, the image encoding model, and the audio encoding model comprises:
first adjusting, to minimize a first plurality of distances, the text encoding model and the audio encoding model, each distance in the first plurality of distances comprising a distance between a label encoding and a corresponding audio encoding in the vector space;
second adjusting, to minimize a second plurality of distances, the text encoding model and the image encoding model, each distance in the second plurality of distances comprising a distance between a label encoding and a corresponding video encoding in the vector space, the second adjusting performed subsequent to the first adjusting; and
third adjusting, to minimize a third plurality of distances, the text encoding model and the audio encoding model, each distance in the third plurality of distances comprising a distance between a label encoding and a corresponding audio encoding in the vector space, the third adjusting performed subsequent to the second adjusting.
